(19) United States
(12) Patent Application Publication
(10) Pub. No.: US 2004/0225494 A1
(43) Pub. Date: Nov. 11, 2004

(54) Mitigation of interference on digital voice channels

(76) Inventors: Kevin B. Mayginnes, Carol Stream, IL (US); Darrell J. Stogner, Plantation, FL (US)

Correspondence Address: MOTOROLA, INC., 1303 EAST ALGONQUIN ROAD, IL01/3RD, SCHAUMBURG, IL, 60196

(21) Appl. No.: 10/431,253

(22) Filed: May 7, 2003

(51) Int. Cl. G10L 11/06

(52) U.S. Cl. 704/215

(57) ABSTRACT

In a digital voice communication system, a transmitting radio (100/102) checks for activity on a channel. If activity is not detected on the channel, the transmitting radio transmits at least one voice frame on the channel. If activity is detected on the channel, the transmitting radio temporarily buffers the at least one voice frame and waits a period of time prior to re-checking the channel for activity. If activity is still detected on the channel, the transmitting radio repeats the step of waiting until activity is no longer detected on the channel; otherwise, the transmitting radio transmits the at least one voice frame that was temporarily buffered.

### FIELD OF THE INVENTION

The present invention relates generally to mitigation of interference on digital voice channels.

### BACKGROUND OF THE INVENTION

Over the last several years there has been mass migration from analog voice communication systems to digital voice communication systems. Digital voice communication systems offer many advantages over analog voice communication systems, including, but not limited to, bandwidth efficiency, audio clarity, and rich feature sets. Individuals using analog voice communication systems, however, have grown accustomed to certain aspects of these systems that are no longer characteristic of digital voice communication systems.

One such aspect of an analog voice communication system that is no longer characteristic of a digital voice communication system that is of particular importance to public safety two-way radio users is the ability to hold simultaneous conversations on the same channel of a frequency division multiple access (“FDMA”) system. For example, fire fighters responding to a call typically operate their radios in a conventional mode of operation, where no trunking system exists to route calls to traffic channels. The fire fighters transmit on the channel in an ad hoc manner, with the calls frequently overlapping in time. This overlapping results in very strong co-channel interference on the channel, which degrades the audio quality in an analog frequency modulation (“FM”) or amplitude modulation (“AM”) system. The user population has acclimated to this facet of analog communication, and is able to discern multiple coincident calls with remarkable consistency.

Unfortunately for digital modulations, the level of co-channel interference is catastrophic and results in a complete loss of information. As illustrated in FIG. 1, a first transmitting radio (“R1”) 100 and a second transmitting radio (“R2”) 102 are transmitting at the same time to a third receiving radio (“R3”) 104. In the present invention, R1 100 and R2 102 act as transmitting radios and R3 104 act as the receiving radio, however, any of the radios 100, 102, 104 can transmit and/or receive. In this example, R1 100 begins transmitting at time t₁, and after a few digital voice packets 106 are transmitted, R2 102 begins transmitting its own digital voice packets 108 at time t₂. Packets that overlap in time 110 collide and are lost. Eventually, R1 100 stops transmitting packets at time t₃. There will be potentially more packets 112 from R2 102 lost until R3 104 is able to correctly synchronize with the transmit symbol timing.

Current solutions to address this collision problem, including what is called polite transmission, involve R2 102 checking for activity on the channel before attempting to transmit on the channel. If any activity is detected on the channel, R2 102 informs the user that communication is impossible. The user would then be forced to try transmitting at a later time. As illustrated in FIG. 2, when R2 102 attempts to transmit on the channel at time t₂, it detects the packets 106 from R1 100. Rather than transmitting, R2 102 blocks the voice packets 200. R3 104 now correctly receives all packets 202 from R1 100. While this is an improvement, user feedback has shown intense dissatisfaction with this solution, particularly in the public safety arena, where hazardous conditions make it difficult for a user to continuously attempt transmissions.

Thus, there exists a need for better mitigation of interference on digital voice channels.

### BRIEF DESCRIPTION OF THE FIGURES

A preferred embodiment of the invention is now described, by way of example only, with reference to the accompanying figures in which:

FIG. 1 (prior art) illustrates a scenario where two radios collide and all communication is lost;

FIG. 2 (prior art) illustrates a scenario where R2 detects a transmission from R1 and prevents the user from speaking;

FIG. 3 illustrates a state transition diagram of the radio operation in accordance with the preferred embodiment of the present invention;

FIG. 4 illustrates an example of the radio operation of FIG. 3 in accordance with the preferred embodiment of the present invention; and

FIG. 5 illustrates an optional feature of the example of FIG. 4 in accordance with the preferred embodiment of the present invention.

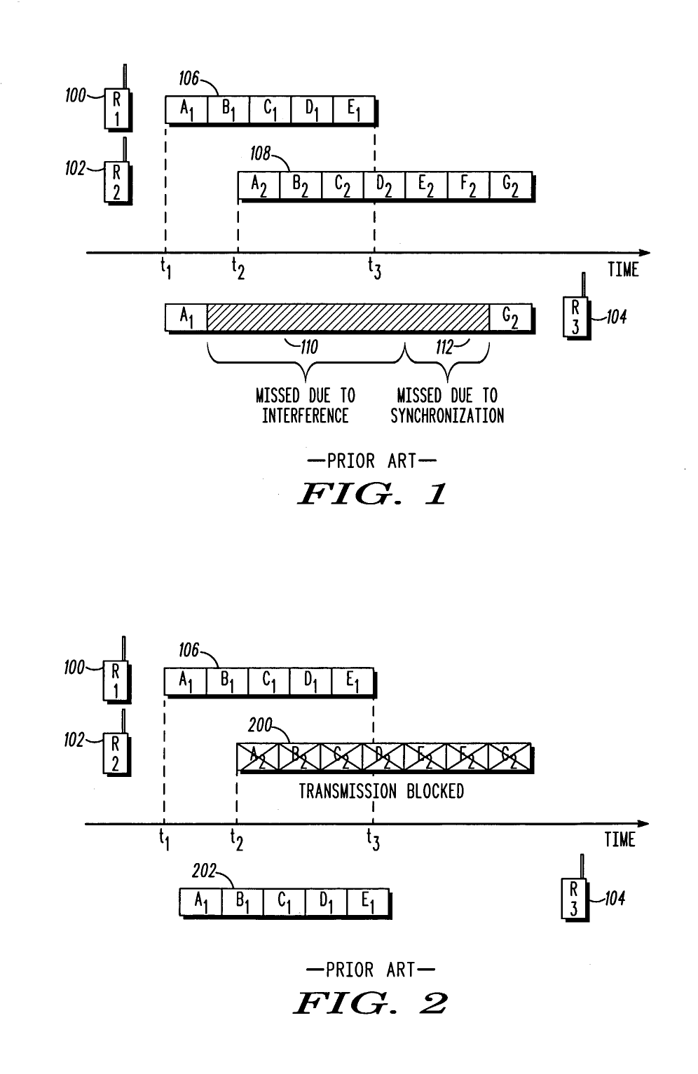

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

The present invention relates generally to an improved method for handling co-channel interference on digital voice channels, and particularly for conventional frequency division multiple access channels. Instead of prohibiting a user from transmitting on a channel when activity is detected, as described in the background, the present invention buffers (stores) voice frames for a period of time (e.g., tens of seconds) in the memory of the radio until the channel becomes clear. The buffered voice frames would then be transmitted over the air without interference. Additionally, the present invention prevents voice frames that contain only silence from being transmitted over the air.

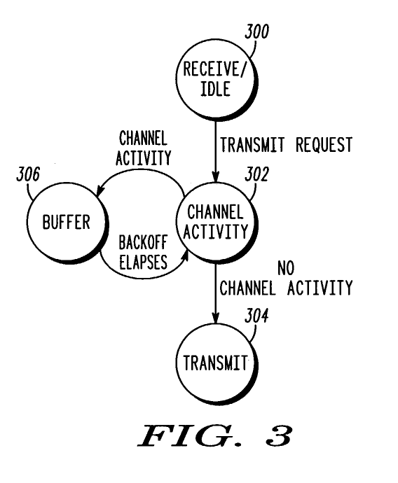

FIG. 3 illustrates a state transition diagram of the operation of the transmitting radio 100/102 in accordance with the preferred embodiment of the present invention. As illustrated, the transmitting radio 100/102 powers up in a receiving or idle state (300). When the user of the transmitting radio 100/102 desires to transmit voice frames over the air, the transmitting radio 100/102 checks for channel activity (302). For purposes of the present invention, channel activity is the presence of a valid signal on the channel of a defined strength, wherein the defined strength can vary depending on system parameters. Further, the validity of a signal may be determined by, but not limited to, at least one of the following criteria: carrier presence/channel power, modulation, synchronization patterns, network access code (NAC), or the like. Thus, if no activity is detected on the channel, the transmitting radio 100/102 temporarily buffers the voice frames, enters a transmit state (304), and immediately transmits the buffered voice frames over the air in its normal fashion as known to those individuals of ordinary skill in the art. If activity, however, is detected on the channel at the time the user desires to transmit, the transmitting radio 100/102 temporarily buffers the voice frames for a period of time (306). The period of time in which the voice frames are buffered is dependent on the length of time activity remains on the channel.

When activity is detected on the channel and the voice frames are buffered, the transmitting radio 100/102 waits a back-off time before rechecking the channel for activity. The back-off time is an amount of time that must elapse before the transmitting radio 100/102 is permitted to recheck the channel for activity (302). The back-off time minimizes interference by several transmitting radios that detect the idle channel at the same time. Additionally, the back-off time may be a random amount of time reselected each time the radio detects channel activity or a predetermined amount of time, depending on system requirements. For example, R1 100 is likely to select a different back-off time than R2 102, thus the probability of R1 100 checking the channel for activity at the same time as R2 102 is significantly reduced. In accordance with the present invention, the transmitting radio 100/102 must wait the back-off time prior to rechecking the channel for activity (302); thus, the transmitting radio 100/102 continues to wait the back-off time and recheck the channel for activity until the channel becomes idle. Once the channel idle criteria are met (e.g., no activity is detected on the channel), and the back-off time is satisfied, the transmitting radio 100/102 retrieves and transmits the buffered voice frames over the radio frequency (“RF”) interface on the channel. It is important to note that the transmitting radio 100/102 automatically buffers the voice frames, continuously waits the back-off time and rechecks the channel for activity until the channel idle criteria are met and the back-off time satisfied, and/or automatically transmits the buffered voice frames on the channel without any further intervention from the user.

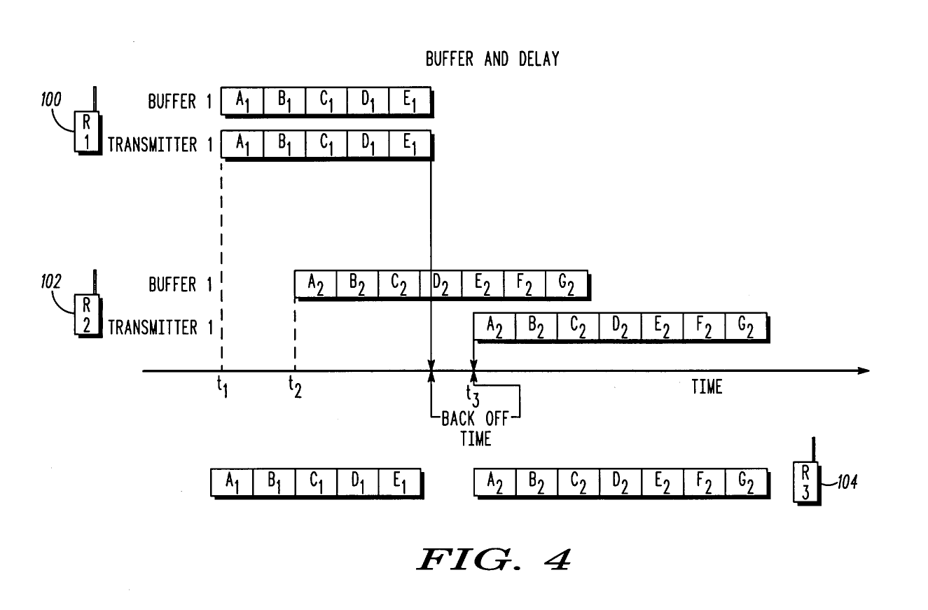

FIG. 4 illustrates an example of the preferred embodiment of the present invention. In this example, R1 100 desires to transmit information over the RF interface to R3 104. Prior to transmitting, R1 100 determines whether there is any activity on the channel. In this example, there is no activity on the channel when R1 100 desires to transmit, thus, R1 100 buffers and immediately transmits the voice frames at time t₁.

While R1 100 is transmitting, R2 102 desires to transmit information on the same channel. As such, R2 102 determines whether there is activity on the channel. Since R1 100 is currently transmitting on the channel, R2 102 detects the activity from R1 100 and begins to temporarily buffer its transmission (i.e., the voice frames) at time t₂ in accordance with the present invention. After waiting the back-off time, R2 102 determines whether the channel idle criteria are met by rechecking the channel for activity. If the channel idle criteria are not met when R2 102 rechecks the channel for activity, R2 102 waits the back-off time before rechecking the channel for activity. In accordance with the present invention, R2 102 waits the back-off time each time R2 102 checks the channel and the channel idle criteria are not met.

As soon as the channel idle criteria has been met, and the back-off time is satisfied, R2 102 retrieves the buffered voice frames and begins to transmit the buffered voice frames on the channel at time t₃. As a result, R3 104 receives both transmissions without interference starting at time t₁ and t₃, respectively.

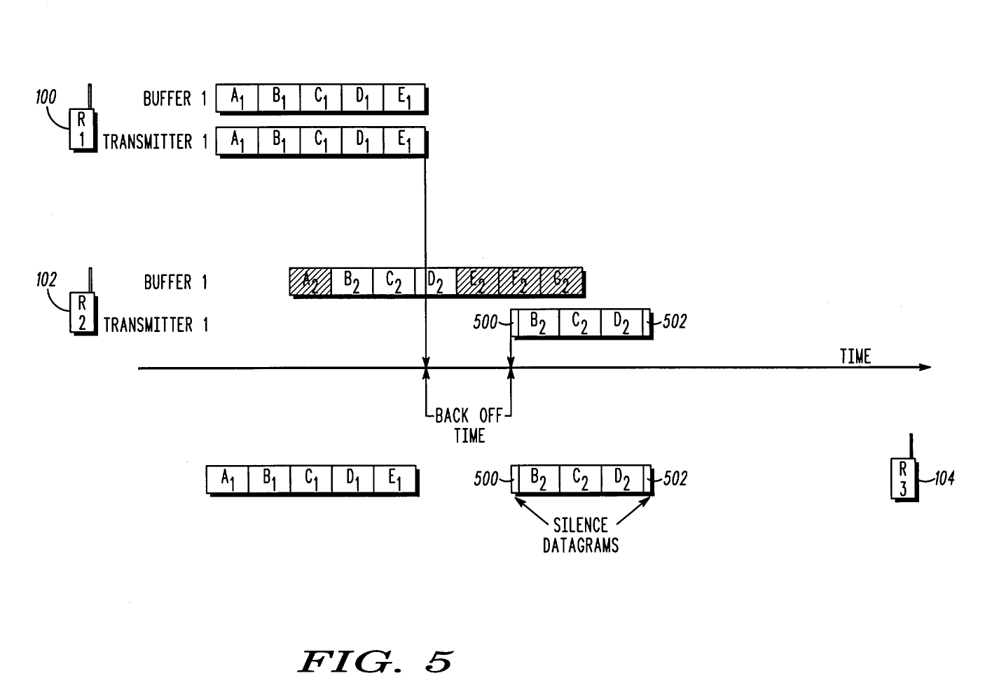

In addition to temporarily buffering the voice frames for a period of time when there is activity on the channel, the present invention enables the transmitting radio 100/102 to determine if there are any frames in the buffered voice that contain only silence. If there are any frames in the buffered voice that contain only silence, the transmitting radio 100/102 removes these silent frames from the buffered voice and optionally replaces them with silence datagrams prior to transmitting the buffered voice frames on the channel. The silence datagram indicates the amount of silence removed from the buffered voice frames so that it can be reproduced at the receiving radio 104. Removing frames of silence from the buffered voice reduces transmission time on the channel. An example of removing frames of silence from the buffered voice is illustrated in FIG. 5.

Continuing the example from FIG.4, prior to R2 102 transmitting its buffered voice frames on the channel at time t₃, R2 102 determines whether there are any frames containing only silence. In this example, as illustrated in FIG. 5, R2 102 determines that frames A₂, E₂, F₂ and G₂ contain only silence. In accordance with the present invention, R2 102 removes these frames of silence from the buffered voice and replaces the frames of silence with silent datagrams 500, 502. As such, when R2 102 transmits the buffered voice frames on the channel, only frames B₂, C₂ and D₂ are transmitted in their entirety, along with a first silence datagram 500 replacing frame A₂, and a second silence datagram 502 replacing frames E₂, F₂, and G₂. As illustrated, continuous frames of silence can be replaced with a single silence datagram 502 in the transmission in accordance with the present invention. Alternatively, all the frames of silences (continuous and non-continuous) may be identified in a single silence datagram and still remain in the spirit and scope of the present invention.

Optionally, the transmitting radio 100/102 can provide audio feedback (e.g., a tone, a bell, or the like) to the user to indicate a certain event/activity has taken place. For example, the transmitting radio 100/102 may provide audio feedback to the user when the at least one voice frame that is temporarily buffered is over a predetermined length so that the voice storage memory will not overflow; the transmitting radio 100/102 may provide audio feedback to the user when the at least one voice frame that is temporarily buffered has remained in memory for a predetermined amount of time; the transmitting radio 100/102 may provide audio feedback to the user upon detecting activity on the channel and/or the start of temporarily buffering the at least one voice frame into memory; the transmitting radio 100/102 may provide audio feedback to the user upon start of transmitting the at least one voice frame that was temporarily buffered on the channel; the transmitting radio 100/102 may provide audio feedback to the user upon completing the transmission of the at least one voice frame that was temporarily buffered. It will be readily obvious to those individual of ordinary skill in the art that the transmitting radio 100/102 can provide audio feedback to the user to indicate other events and/or activities not listed above and still remain within the spirit and scope of the present invention.

Thus, the present invention does not prevent a user of a radio 100/102 from communicating when desired. If activity is detected on the channel when the user desires to transmit, the present invention automatically buffers the user's voice temporarily and transmits the buffered voice frame(s) on the channel without any further intervention from the user when the channel idle criteria is met and the back-off time is satisfied. Thus, from the perspective of the user, the radio operates in its normal fashion.

It should be noted that the present invention might be implemented in software, hardware and/or firmware. Thus, for example, a storage medium having stored thereon a set of instructions, which when loaded into a hardware device (e.g., a microprocessor) residing on the radio 100/102/104, causes the hardware device to perform the functions of the present invention.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. For example, if activity is not present on the channel, the transmitting radio may immediately transmit the voice frames rather than buffering the voice frames and immediately transmitting the buffered voce frames as described above and illustrated in the figures. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. In a digital voice communication system, a method comprising the steps of:
checking a channel for activity;
if activity is not detected on the channel, transmitting the at least one voice frame on the channel; and
if activity is detected on the channel,
temporarily buffering at least one voice frame;
waiting a period of time prior to re-checking the channel for activity; and
if activity is still detected on the channel, repeating the step of waiting until activity is no longer detected on the channel;
otherwise, transmitting the at least one voice frame that was temporarily buffered on the channel.

2. The method of claim 1 wherein the period of time waited prior to rechecking the channel for activity is randomly selected each time activity is detected on the channel.

3. The method of claim 1 wherein the period of time waited prior to rechecking the channel for activity is the same each time activity is detected on the channel.

4. The method of claim 1 further comprising the step of temporarily buffering the at least one voice frame prior to the step of transmitting when activity is not detected on the channel, and wherein the step of transmitting the at least one voice frame on the channel when activity is not detected on the channel comprises transmitting the at least one voice frame that was temporarily buffered.

5. The method of claim 1 further comprising the steps of:
detecting a frame of silence in the at least one voice frame that was temporarily buffered when activity is detected on the channel; and
removing the frame of silence from the at least one voice frame that was temporarily buffered.

6. The method of claim 5 further comprising the step of replacing the frame of silence with a silence datagram prior to transmitting the at least one voice frame that was temporarily buffered.

7. The method of claim 1 wherein the at least one voice frame is temporarily buffered into a memory, and further comprising the step of removing the at least one voice frame from the memory when the at least one voice frame is transmitted.

8. The method of claim 1 wherein the at least one voice frame is temporarily buffered into a memory, and further comprising the step of providing audio feedback when the at least one voice frame has remained in the memory for a predetermined amount of time.

9. The method of claim 1 further comprising the step of providing audio feedback upon the step of temporarily buffering the at least one voice frame.

10. The method of claim 1 further comprising the step of providing audio feedback upon the step of transmitting the at least one voice frame that was temporarily buffered on the channel.

11. The method of claim 1 further comprising the step of providing audio feedback upon completion of the step of transmitting the at least one voice frame that was temporarily buffered.

12. The method of claim 1 further comprising the step of providing audio feedback when the at least one voice frame is over a predetermined length.

13. The method of claim 1 wherein at least one step is stored on a storage medium which when loaded into a hardware device causes a radio to perform the at least one step.

14. The method of claim 1 wherein the step of checking a channel for activity comprises analyzing at least one of the following criteria on the channel: channel power, carrier presence, synchronization patterns, modulation, and network access code.
